(19) United States
(12) Patent Application Publication
(10) Pub. No.: US 2024/0118128 A1
(43) Pub. Date: Apr. 11, 2024

(54) SIGNAL PROCESSING APPARATUS, SIGNAL PROCESSING METHOD, AND NON-TRANSITORY COMPUTER READABLE MEDIUM

(71) Applicant: NEC Corporation, Tokyo (JP)

(72) Inventors: Sakiko MISHIMA, Tokyo (JP); Wataru Kohno, Tokyo (JP); Takashi Matsushita, Tokyo (JP); Tomoyuki Hino, Tokyo (JP)

(73) Assignee: NEC Corporation, Tokyo (JP)

(21) Appl. No.: 18/374,161

(22) Filed: Sep. 28, 2023

(30) Foreign Application Priority Data
Oct. 3, 2022 (JP) 2022-159782

(51) Int. Cl. G01H 9/00

(52) U.S. Cl. CPC G01H 9/004

(57) ABSTRACT

A signal processing apparatus according to the present disclosure includes: at least one memory configured to store instructions; and at least one processor configured to execute the instructions to: acquire signals measured by a signal measurement apparatus at a plurality of points located along an optical fiber; and determine whether there is an event based on a degree of similarity between the signals measured at points adjacent points.

### INCORPORATION BY REFERENCE

This application is based upon and claims the benefit of priority from Japanese patent application No. 2022-159782, filed on Oct. 3, 2022, the disclosure of which is incorporated herein in its entirety by reference.

### TECHNICAL FIELD

The present disclosure relates to a signal processing apparatus, a signal processing method, and a non-transitory computer readable medium.

### BACKGROUND ART

Through a technology referred to as optical fiber sensing, it is possible to detect vibrations and sounds applied to an optical fiber at a plurality of points located along the optical fiber.

In recent years, technologies for detecting events such as anomalies that have occurred at a plurality of points located along an optical fiber by detecting vibrations and sounds at the plurality of points using optical fiber sensing have been proposed (e.g., International Patent Publication No. WO 2021/059507 and International Patent Publication No. WO 2022/044203).

Incidentally, one example of optical fiber sensing is Distributed Acoustic Sensing (DAS).

A DAS apparatus inputs coherent pulsed light into an optical fiber and receives backscattered light of the pulsed light from the optical fiber. The DAS apparatus then detects the phase difference of the backscattered light generated at each of two points located on the optical fiber, thereby detecting vibrations and sounds applied to the optical fiber in the interval (gauge length) between the two points.

At this time, the DAS apparatus handles a time-series signal such as a waveform signal indicating a temporal change in the phase difference detected in any gauge length as a time-series signal at one point (channel), and measures the time-series signal at each of a plurality of points located along the optical fiber.

As described above, in recent years, optical fiber sensing has been used to detect events such as anomalies.

However, technologies proposed for event detection are mainly technologies using a small number of time-series signals (about a few dozen channels).

Therefore, there is a concern that the computation cost will increase when a technology proposed for event detection is expanded so that it can be applied to a large number of time-series signals (about a few hundred to a few thousand channels).

Further, since the signal quality of a time-series signal differs at each of a plurality of points located along the optical fiber, it is difficult to find time-series signals related to events.

### SUMMARY

Therefore, in view of the problem described above, an object of the present disclosure is to provide a signal processing apparatus, a signal processing method, and a non-transitory computer readable medium that can contribute to the detection of events.

A signal processing apparatus according to an example aspect includes:
at least one memory configured to store instructions; and
at least one processor configured to execute the instructions to:
   acquire signals measured by a signal measurement apparatus at a plurality of points located along an optical fiber; and
   determine whether there is an event based on a degree of similarity between the signals measured at adjacent points.

A signal processing method according to an example aspect is a signal processing method executed by a signal processing apparatus, the signal processing method including:
a signal acquisition step of acquiring signals measured by a signal measurement apparatus at a plurality of points located along an optical fiber; and
a determination step of determining whether there is an event based on a degree of similarity between the signals measured at adjacent points.

A non-transitory computer readable medium according to an example aspect is a non-transitory computer readable medium storing a program for causing a computer to execute:
a signal acquisition procedure for acquiring signals measured by a signal measurement apparatus at a plurality of points located along an optical fiber; and
a determination procedure for determining whether there is an event based on a degree of similarity between the signals measured at adjacent points.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram for explaining a basic principle of each of example embodiments;

FIG. 2 is a diagram showing a configuration example of a signal processing system according to a first example embodiment;

FIG. 3 is a block diagram showing a configuration example of a signal processing apparatus according to the first example embodiment;

FIG. 4 is a diagram showing an example of signals measured by a signal measurement apparatus according to the first example embodiment;

FIG. 5 is a diagram showing a specific example of a waveform signal acquired by a signal acquisition unit according to the first example embodiment;

FIG. 6 is a diagram showing specific examples of a similarity matrix and a weight matrix used by an event determination unit according to the first example embodiment;

FIG. 7 is a diagram showing a specific example of an event score calculated by an event determination unit according to the first example embodiment;

FIG. 8 is a flow diagram showing an example of a flow of schematic operations performed by the signal processing apparatus according to the first example embodiment;

FIG. 9 is a block diagram showing a configuration example of a signal processing apparatus according to a second example embodiment; and

FIG. 10 is a block diagram showing an example of a hardware configuration of a computer that implements the signal processing apparatus according to each of the example embodiments.

### EXAMPLE EMBODIMENT

Example embodiments of the present disclosure will be described hereinafter with reference to the drawings. Note that, for the clarification of the description, the following descriptions and the drawings are partially omitted and simplified as appropriate. Further, the same elements are denoted by the same reference symbols throughout the drawings, and redundant descriptions are omitted as necessary. Further, specific numerical values and the like stated in the following example embodiments are merely examples for facilitating understanding of the present disclosure, and are not limited thereto.

### Basic Principle of Each Example Embodiment

Prior to describing the example embodiments, a basic principle of each of the example embodiments will be given.

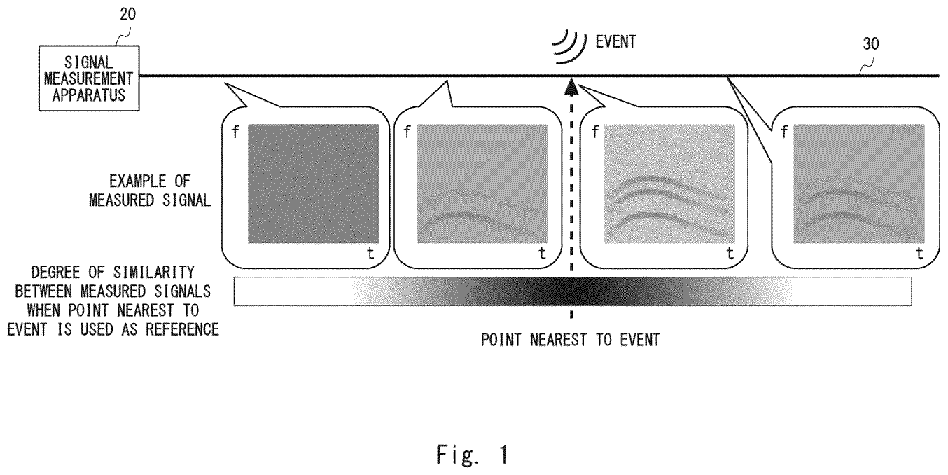

FIG. 1 is a diagram for explaining the basic principle of each of the example embodiments.

As shown in FIG. 1, a signal measurement apparatus 20, which is connected to an optical fiber 30, measures signals (e.g., time-series signals such as waveform signals indicating time changes in phase differences within the gauge length) at a plurality of points (channels) located along the optical fiber 30. The signal measurement apparatus 20 is, for example, a DAS apparatus.

In the example shown in FIG. 1, the signal measurement apparatus 20 measures signals at four points located along the optical fiber 30. Further, in FIG. 1, each of the signals at the four points is a frequency spectrum obtained by performing Fourier transform on the waveform signal described above.

In the example shown in FIG. 1, an event has occurred near the optical fiber 30. It can be seen in FIG. 1 that when an event has occurred, the signals measured at a plurality of adjacent points near the point where the event has occurred are similar to each other. This is because respective distances between points that serve as adjacent channels on the optical fiber 30 are short and thus these points are continuously disposed even in real space.

On the other hand, although not shown in FIG. 1, when no event has occurred, the signals measured at a plurality of adjacent points are not similar to each other. In this case, a dominant noise mixed into each signal is white noise, and the correlation of the dominant noises among the plurality of points is low.

Therefore, in each of the example embodiments described below, the degree of similarity between signals at the adjacent points is calculated, and when the degree of similarity between the signals is high, it is determined that an event (such as an anomaly) has occurred.

Each of the example embodiments according to the present disclosure will be described below.

### First Example Embodiment

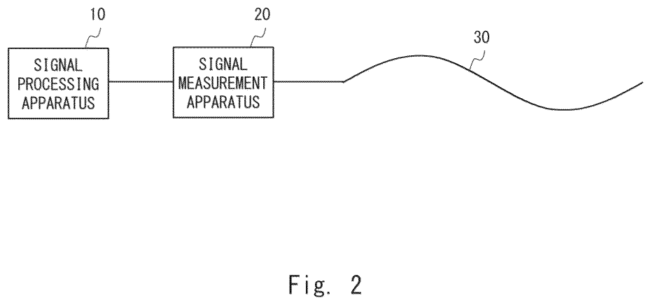

FIG. 2 is a diagram showing a configuration example of a signal processing system according to a first example embodiment.

As shown in FIG. 2, the signal processing system according to the first example embodiment includes a signal processing apparatus 10, the optical fiber 30, and the signal measurement apparatus 20.

The signal measurement apparatus 20 and the optical fiber 30 are similar to those shown in FIG. 1.

The signal processing apparatus 10, which is connected to the signal measurement apparatus 20, acquires signals (e.g., time-series signals such as waveform signals indicating time changes in phase differences within the gauge length) measured by the signal measurement apparatus 20 at a plurality of points located along the optical fiber 30 from the signal measurement apparatus 20.

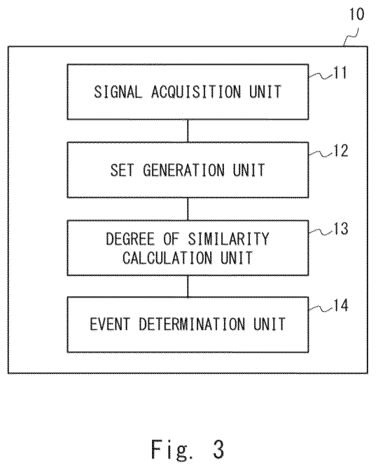

FIG. 3 is a block diagram showing a configuration example of the signal processing apparatus 10 according to the first example embodiment.

As shown in FIG. 3, the signal processing apparatus 10 according to the first example embodiment includes a signal acquisition unit 11, a set generation unit 12, a degree of similarity calculation unit 13, and an event determination unit 14.

The signal acquisition unit 11 acquires, from the signal measurement apparatus 20, signals measured by the signal measurement apparatus 20 at a plurality of points located along the optical fiber 30, and parameters related to the measurement.

The set generation unit 12 generates, for each of the plurality of points, a set including a point where a degree of similarity between a signal at this point and a signal at a target point is to be calculated.

The degree of similarity calculation unit 13 calculates, for each of the plurality of points, a degree of similarity between the signal at a target point and a signal at each of the points included in the set in which the target point is included.

The event determination unit 14 determines, for each of the plurality of points, whether there is an event based on the degree of similarity between the signal at a target point and a signal at an adjacent point that is adjacent to the target point.

The components of the signal processing apparatus 10 according to the first example embodiment will be described in detail below.

### (1) Signal Acquisition Unit 11

First, the signal acquisition unit 11 will be described in detail.

The signal acquisition unit 11 acquires signals measured by the signal measurement apparatus 20 at a plurality of points located along the optical fiber 30 from the signal measurement apparatus 20.

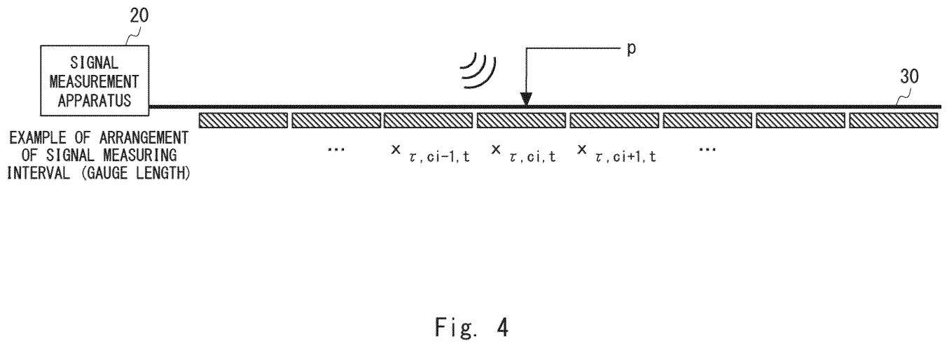

For example, as shown in FIG. 4, the signal acquisition unit 11 acquires, as signals at a plurality of points located along the optical fiber 30, waveform signals indicating the time changes in the phase differences within each gauge length. The signal indices shown in FIG. 4 are as follows.
x: waveform signal
τ: Frame index
cᵢ: Signal channel index (0≤i,j<C), cᵢ=H(p)
t: Time in frame
p: Position on the optical fiber
H(⋅): Transform function that transforms the position on the optical fiber into a signal index

Further, the signal acquisition unit 11 acquires the above-described signal index from the signal measurement apparatus 20 as a parameter related to measurement and acquires a gauge length.

As described above, waveform signals are distinguished by a signal index.

Further, by using a transform function

H(⋅)

that transforms the position on the optical fiber 30 into a signal index, it is possible to specify the position on the optical fiber 30 where each of the waveform signals was measured.

Note that the position on the optical fiber 30 is any position within the gauge length where each of the waveform signals was measured. Any position within the gauge length is, for example, the position at the center of the interval of the gauge length.

Note that, although the transform function that transforms the position on the optical fiber 30 into a signal index is defined here, it is also possible to define a transform function that transforms the signal index into the position on the optical fiber 30.

### (2) Set Generation Unit 12

Next, the set generation unit 12 will be described in detail.

The set generation unit 12 generates, for each of the plurality of points, a set including a point where a degree of similarity between a signal at this point and a signal at a target point is to be calculated.

At this time, the set can be set freely.

Further, the set in which a target point is included may include all of the points (excluding the target point) where the signals were measured. Alternatively, an adjacent point that is adjacent to the target point may be selected, and a point to be included in the set in which the target point is included may be limited to the selected adjacent point.

Further, when a point to be included in the set in which the target point is included is limited to the adjacent point, the set may be generated by taking the continuity of the optical fibers 30 into account.

For example, when the channel of the optical fibers 30 is used as a reference, the points located within the range of a predetermined number times the gauge length (e.g., a times) from the target point may be included in the set in which the target point is included.

Further, when the distance in the real space distribution of the optical fibers 30 is used as a reference, the points located within the range of a predetermined distance (e.g., a distance d[m]) from the target point may be included in the set in which the target point is included.

### (3) Degree of Similarity Calculation Unit 13

Next, the degree of similarity calculation unit 13 will be described in detail.

The degree of similarity calculation unit 13 calculates, for each of the plurality of points, a degree of similarity between the signal at a target point and a signal at each of the points included in the set in which the target point is included.

That is, the degree of similarity calculation unit 13 sequentially calculates the degree of similarity of two signals (the signal at the target point and the signal at any one point in the set in which the target point is included).

At this time, a waveform signal, a signal in the frequency domain or a signal in the time/frequency domain in which the waveform signal has been transformed can be used as a signal used for the calculation of the degree of similarity.

For example, as the waveform signal, the signal itself measured by the signal measurement apparatus 20 (the waveform signal indicating the time change in the phase difference within the gauge length), the signal obtained by applying any filter such as a bandpass filter to the waveform signal, and the signal in which the waveform signal is noise-suppressed can be used.

Further, as the signal in the frequency domain, a frequency spectrum and the like obtained by transforming the waveform signal described above using Fourier transform, Constant Q transform (CQT), etc. can be used.

Further, as the signal in the time/frequency domain, a spectrogram and the like in which the signals in the frequency domain described above are arranged in time series can be used.

As a method for calculating the degree of similarity, methods using cross-correlation, correlation coefficient, inner product, cosine of the angle formed, covariance, Euclidean distance, Mahalanobis distance, cosine similarity, Pearson product-moment correlation coefficient, etc. can be used.

For example, when, from among the above methods, a method using a correlation function is used, the correlation function is obtained as follows.

$${r}_{τ , {c}_{i} , {c}_{j}} = \frac{{\sum }_{t} [ ( {x}_{τ , {c}_{i} , t} - \overline{{x}_{τ , {c}_{i}}} ) ( {x}_{τ , {c}_{j} , t} - \overline{{x}_{τ , {c}_{j}}} ) ]}{\sqrt{{\sum }_{t} {( {x}_{τ , {c}_{i} , t} - \overline{{x}_{τ , {c}_{i}}} )}^{2} \times {\sum }_{t} {( {x}_{τ , {c}_{j} , t} - \overline{{x}_{τ , {c}_{j}}} )}^{2}}}$$

Here, the parameters are as follows.
r: Correlation coefficient
τ: Frame index
cᵢ: Signal channel index (0≤i,j<C)
t: Time in frame
x: waveform signal
x̅: In-frame root mean square of the waveform signal

### (4) Event Determination Unit 14

Next, the event determination unit 14 will be described in detail.

The event determination unit 14 determines, for each of the plurality of points, whether there is an event based on the degree of similarity between the signal at a target point and a signal at an adjacent point that is adjacent to the target point.

At this time, the event determination unit 14 calculates an event score for each of the plurality of points, and when the calculated event score is equal to or greater than a threshold, the event determination unit 14 may determine that an event has occurred.

For example, the event score can be calculated by multiplying a similarity matrix indicating the degree of similarity between signals by a weight matrix indicating the aggregate range of spatial information, and adding a result of the multiplication.

Specifically, when the similarity matrix is

R_{τ,C}_{ᵢ}

and the weight matrix is

W^{P}^{ₙ},

the event score

a_{τ,C}_{ᵢ}

can be calculated as follows.

$${a}_{τ , {c}_{i}} = \frac{1}{{P}_{n} \times {P}_{n}} \sum {R}_{τ , {c}_{i}} ⊙ {W}^{{P}_{n}}$$

Here, the similarity matrix and the weight matrix can be, for example, the following matrices, respectively:

$${R}_{τ , {c}_{i}} = [ \begin{matrix}{r}_{τ , {c}_{i} , {c}_{i}} & … & {r}_{τ , {c}_{i + {P}_{n}} , {c}_{i}} \\ ⋮ & ⋱ & ⋮ \\ {r}_{τ , {c}_{i} , {c}_{i + {P}_{n}}} & … & {r}_{τ , {c}_{i + {P}_{n}} , {c}_{i + {P}_{n}}}\end{matrix} ]$$

$${W}^{{P}_{n}} = [ \begin{matrix}0 & \frac{1}{{P}_{n} - 1} & \frac{2}{{P}_{n} - 1} & … & 1 \\ & 0 & \frac{1}{{P}_{n} - 1} & ⋱ & ⋮ \\ ⋮ & & 0 & \frac{1}{{P}_{n} - 1} & \frac{2}{{P}_{n} - 1} \\ & & & 0 & \frac{1}{{P}_{n} - 1} \\ 0 & & … & & 0\end{matrix} ]$$

The parameters are as follows.
r: Degree of similarity (e.g., correlation coefficient)
τ: Frame index
cᵢ: Signal channel index (0≤i,j<C)
Pₙ: Weight range
⊙: Element product of a matrix

Note that the value of the degree of similarity to be stored in the similarity matrix may be a value of the degree of similarity calculated by any of the above-described methods for calculating the degree of similarity.

Further, the weight range Pn may be set by taking the continuity of the optical fiber 30 into account.

For example, when the channel of the optical fiber 30 is used as a reference, Pn may be set within a range of a predetermined number times (e.g., a times) the gauge length from the target point. In this case, Pn=aG.

Further, when the distance in the real space distribution of the optical fiber 30 is used as a reference, Pn may be set within the range of a predetermined distance (e.g., the distance d[m]) from the target point. In this case,

Pₙ=\acute{H}(max(d))

holds.

Further, the weights can be equal or different for all signals. For example, the weights may be increased in accordance with the distance from the target point. By doing so, an effect that signals propagated over a wide area can be robustly detected will be achieved.

A specific example of data processed by the signal processing apparatus 10 according to the first example embodiment will be described below.

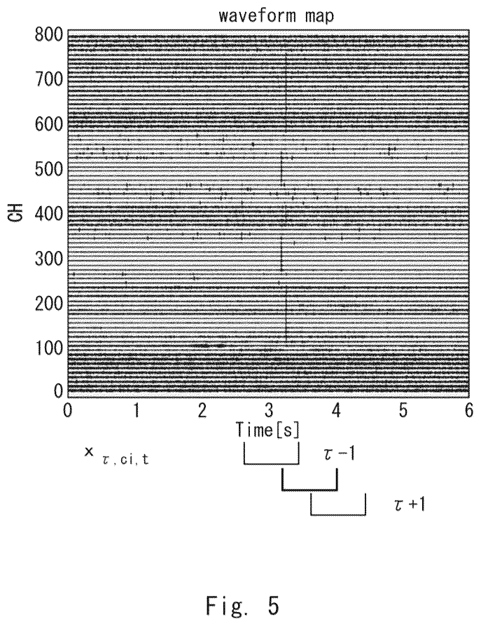

FIG. 5 is a diagram showing the waveform signal

x_{τ,C}_{ᵢ}_{,t}

acquired by the signal acquisition unit 11 from the signal measurement apparatus 20. The degree of similarity calculation unit 13 calculates the degree of similarity between the above waveform signals.

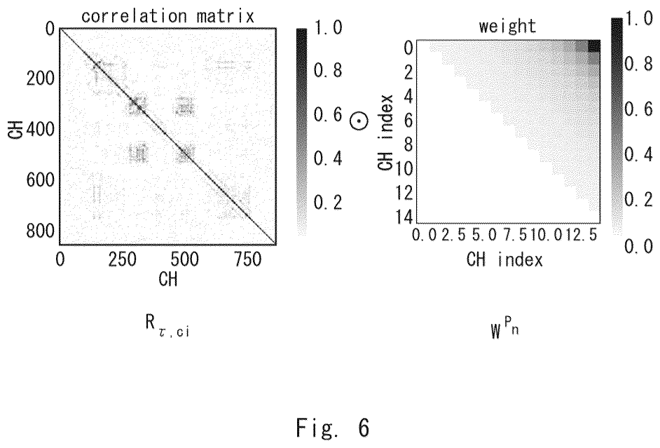

FIG. 6 is a diagram showing specific examples of the similarity matrix

R_{τ,C}_{ᵢ}

and the weight matrix

W^{P}^{ₙ}

used by the event determination unit 14. The event determination unit 14 calculates an event score by multiplying the above similarity matrix by the above weight matrix and adding a result of the multiplication.

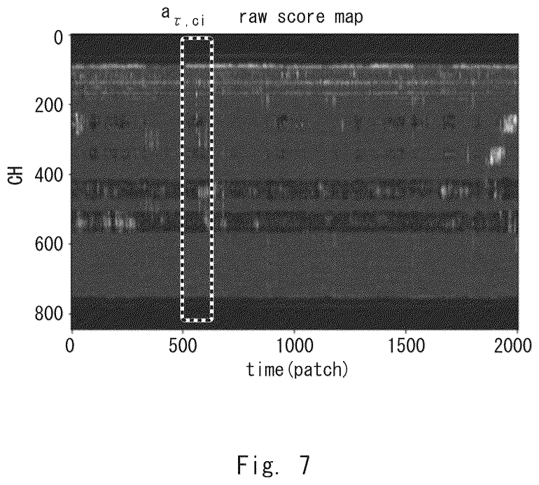

FIG. 7 is a diagram showing a specific example of an event score

a_{τ,C}_{ᵢ}

calculated by the event determination unit 14. The event determination unit 14 determines whether there is an event based on the above event score.

Next, an example of schematic operations performed by the signal processing apparatus 10 according to the first example embodiment will be described.

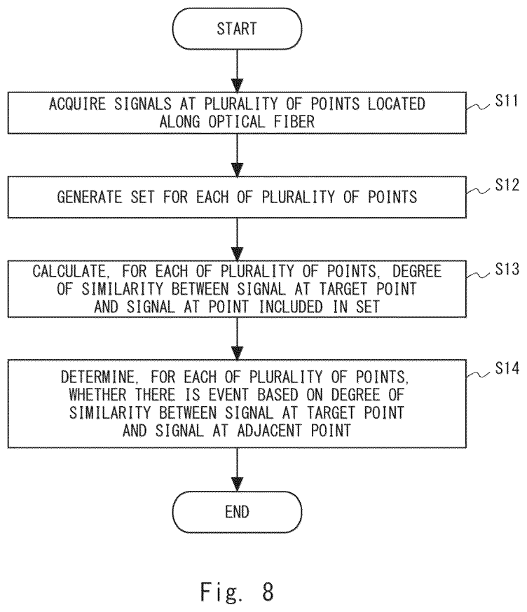

FIG. 8 is a flow diagram for explaining an example of a flow of schematic operations performed by the signal processing apparatus 10 according to the first example embodiment.

As shown in FIG. 8, first, the signal acquisition unit 11 acquires signals measured by the signal measurement apparatus 20 at a plurality of points located along the optical fiber 30 from the signal measurement apparatus 20 (Step S11).

Next, the set generation unit 12 generates, for each of the plurality of points, a set including a point where a degree of similarity between a signal at this point and a signal at a target point is to be calculated (Step S12).

Next, the degree of similarity calculation unit 13 calculates, for each of the plurality of points, a degree of similarity between the signal at a target point and a signal at each of the points included in the set in which the target point is included (Step S13).

Then, the event determination unit 14 determines, for each of the plurality of points, whether there is an event based on the degree of similarity between the signal at a target point and a signal at an adjacent point that is adjacent to the target point (Step S14).

As described above, according to the first example embodiment, the signal acquisition unit 11 acquires signals at a plurality of points located along the optical fiber 30. The set generation unit 12 generates, for each of the plurality of points, a set including a point where a degree of similarity between a signal at this point and a signal at a target point is to be calculated. The degree of similarity calculation unit 13 calculates, for each of the plurality of points, a degree of similarity between the signal at a target point and a signal at each of the points included in the set in which the target point is included. The event determination unit 14 determines, for each of the plurality of points, whether there is an event based on the degree of similarity between the signal at a target point and a signal at an adjacent point that is adjacent to the target point. By the above configuration, it is possible to contribute to the detection of an event. Further, since determination as to whether there is an event is performed based on the degree of similarity between signals at the adjacent points, the computation cost can be reduced even when it is expanded so that it can be applied to a large number of signals at many points, and it is possible to determine whether there is an event even when the signal qualities of the signals are different from each other.

### Second Example Embodiment

A second example embodiment is equivalent to an example embodiment in which the first example embodiment described above is conceptualized to a superordinate level.

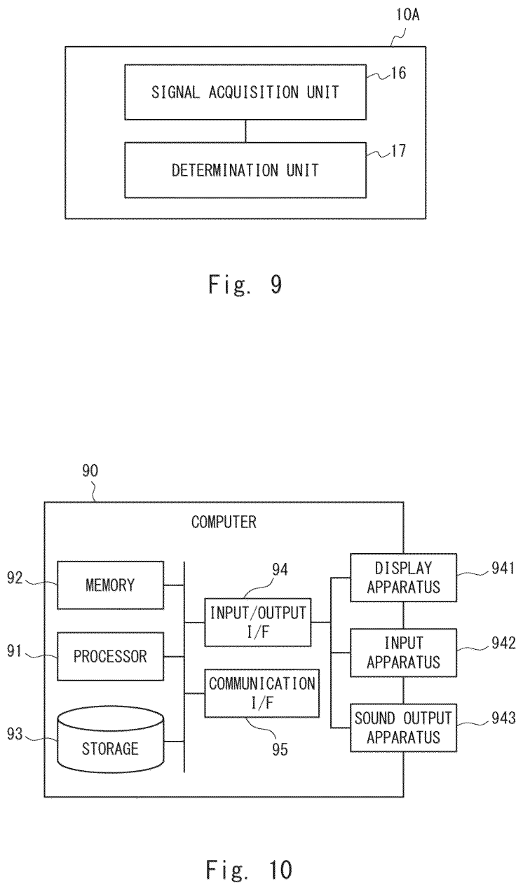

FIG. 9 is a block diagram showing a configuration example of a signal processing apparatus 10A according to the second example embodiment.

As shown in FIG. 9, the signal processing apparatus 10A according to the second example embodiment includes a signal acquisition unit 16 and a determination unit 17.

The signal acquisition unit 16 acquires signals measured by a signal measurement apparatus at a plurality of points located along an optical fiber from the signal measurement apparatus. The signal acquisition unit 16 corresponds to the signal acquisition unit 11 according to the above-described first example embodiment. Further, the signal measurement apparatus corresponds to the signal measurement apparatus 20 according to the above-described first example embodiment.

The determination unit 17 determines whether there is an event based on the degree of similarity between signals measured at the adjacent points. The determination unit 17 corresponds to the set generation unit 12, the degree of similarity calculation unit 13, and the event determination unit 14 according to the above-described first example embodiment. Since the second example embodiment is configured as described above, it can contribute to the detection of an event.

Note that the determination unit 17 may include a set generation unit, a degree of similarity calculation unit, and an event determination unit respectively corresponding to the set generation unit 12, the degree of similarity calculation unit 13, and the event determination unit 14 according to the above-described first example embodiment. The set generation unit generates, for each of the plurality of points, a set including a point where a degree of similarity between a signal at this point and a signal at a target point is to be calculated. Further, the degree of similarity calculation unit calculates, for each of the plurality of points, a degree of similarity between the signal at a target point and a signal at the point included in the set in which the target point is included. Further, the event determination unit determines, for each of the plurality of points, whether there is an event based on the degree of similarity between the signal at a target point and a signal at an adjacent point that is adjacent to the target point.

Further, the set generation unit may select, for each of the plurality of points, an adjacent point that is adjacent to a target point, and include the selected adjacent point in the set in which the target point is included.

Further, the signal measurement apparatus may be an apparatus that handles a signal measured at any gauge length as a signal at one point. In this case, the set generation unit may include in the set in which the target point is included, for each of the plurality of points, a point located within a range of a predetermined number times the gauge length from the target point.

Further, the set generation unit may include in the set in which the target point is included, for each of the plurality of points, a point located within a range of a predetermined distance from the target point.

Further, the degree of similarity calculation unit may perform signal processing on a signal acquired by the signal acquisition unit and calculate the degree of similarity between the signals that have been subjected to the signal processing. For example, signal processing includes filtering processing, noise suppression processing, and transform processing using Fourier transform or CQT.

### Hardware Configuration of the Signal Processing Apparatus According to the Example Embodiment

A hardware configuration of a computer that implements the signal processing apparatuses 10 and 10A according to the above-described first and second example embodiments will be described below.

FIG. 10 is a block diagram showing an example of the hardware configuration of a computer 90 that implements the signal processing apparatuses 10 and 10A according to the above-described first and second example embodiments.

As shown in FIG. 10, the computer 90 includes a processor 91, a memory 92, a storage 93, an input/output interface (an input/output I/F) 94, a communication interface (a communication I/F) 95, and the like. The processor 91, the memory 92, the storage 93, the input/output interface 94, and the communication interface 95 are connected to each other by data transmission lines through which they transmit/receive data to/from each other.

The processor 91 is, for example, an arithmetic processing unit such as a Central Processing Unit (CPU) or a Graphics Processing Unit (GPU). The memory 92 is, for example, a memory such as a Random Access Memory (RAM) or a Read Only Memory (ROM). The storage 93 is, for example, a storage device such as a Hard Disk Drive (HDD), a Solid State Drive (SSD), or a memory card. Further, the storage 93 may be a memory such as a RAM or a ROM.

A program is stored in the storage 93. This program includes instructions (or software codes) that, when loaded into a computer, cause the computer 90 to perform one or more of the functions in the signal processing apparatuses 10 and 10A described above. The components in the signal processing apparatuses 10 and 10A described above may be implemented by the processor 91 loading and the program stored in the storage 93 and executing it. Further, the storage function in the signal processing apparatuses 10 and 10A described above may be implemented by the memory 92 or the storage 93.

Further, the above-described program may be stored in a non-transitory computer readable medium or a tangible storage medium. By way of example, and not a limitation, non-transitory computer readable media or tangible storage media can include a RAM, a ROM, a flash memory, a SSD, or other types of memory technologies, a Compact Disc (CD)-ROM, a Digital Versatile Disc (DVD), a Blu-ray (Registered Trademark) disc, or other types of optical disc storage, and magnetic cassettes, magnetic tape, magnetic disk storage, or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The input/output interface 94 is connected to a display apparatus 941, an input apparatus 942, a sound output apparatus 943, and the like. The display apparatus 941 is an apparatus, such as a Liquid Crystal Display (LCD), a Cathode Ray Tube (CRT) display, or a monitor, which displays a screen corresponding to drawing data processed by the processor 91. The input apparatus 942 is an apparatus that receives an operation input from an operator, and is, for example, a keyboard, a mouse, and a touch sensor. The display apparatus 941 and the input apparatus 942 may be integrated with each other and hence implemented as a touch panel. The sound output apparatus 943 is an apparatus, such as a speaker, which outputs sounds corresponding to acoustic data processed by the processor 91.

The communication interface 95 transmits and receives data to and from an external apparatus. For example, the communication interface 95 communicates with an external apparatus through a wired communication line or a wireless communication line.

Although the present disclosure has been described with reference to the example embodiments, the present disclosure is not limited to the above-described example embodiments. Various changes that may be understood by those skilled in the art may be made to the configurations and details of the present disclosure within the scope of the disclosure.

The first and second example embodiments can be combined as desirable by one of ordinary skill in the art.

The whole or part of the example embodiments disclosed above can be described as, but not limited to, the following supplementary notes.

### (Supplementary Note 1)

A signal processing apparatus comprising:
at least one memory configured to store instructions; and
at least one processor configured to execute the instructions to:
   acquire signals measured by a signal measurement apparatus at a plurality of points located along an optical fiber; and
   determine whether there is an event based on a degree of similarity between the signals measured at adjacent points.

### (Supplementary Note 2)

The signal processing apparatus according to supplementary note 1, wherein
the at least one processor is further configured to execute the instructions to:
   generate, for each of the plurality of points, a set including a point where a degree of similarity between a signal at this point and a signal at a target point is to be calculated;
   calculate, for each of the plurality of points, a degree of similarity between the signal at a target point and a signal at the point included in the set in which the target point is included; and
   determine, for each of the plurality of points, whether there is an event based on the degree of similarity between the signal at a target point and a signal at an adjacent point that is adjacent to the target point.

### (Supplementary Note 3)

The signal processing apparatus according to supplementary note 2, wherein the at least one processor is further configured to execute the instructions to select, for each of the plurality of points, an adjacent point that is adjacent to a target point, and include the selected adjacent point in the set in which the target point is included.

### (Supplementary Note 4)

The signal processing apparatus according to supplementary note 3, wherein
the signal measurement apparatus is an apparatus configured to handle a signal measured at any gauge length as a signal at one point, and
the at least one processor is further configured to execute the instructions to include in the set in which the target point is included, for each of the plurality of points, a point located within a range of a predetermined number times the gauge length from the target point.

### (Supplementary Note 5)

The signal processing apparatus according to supplementary note 3, wherein the at least one processor is further configured to execute the instructions to include in the set in which the target point is included, for each of the plurality of points, a point located within a range of a predetermined distance from the target point.

### (Supplementary Note 6)

The signal processing apparatus according to supplementary note 2, wherein the at least one processor is further configured to execute the instructions to:
perform signal processing on the signal acquired by a signal acquisition unit; and
calculate a degree of similarity between the signals that have been subjected to the signal processing.

### (Supplementary Note 7)

A signal processing method executed by a signal processing apparatus, the signal processing method comprising:
a signal acquisition step of acquiring signals measured by a signal measurement apparatus at a plurality of points located along an optical fiber; and
a determination step of determining whether there is an event based on a degree of similarity between the signals measured at adjacent points.

### (Supplementary Note 8)

The signal processing method according to supplementary note 7, wherein
the determination step comprises:
a set generation step of generating, for each of the plurality of points, a set including a point where a degree of similarity between a signal at this point and a signal at a target point is to be calculated;
a degree of similarity calculation step of calculating, for each of the plurality of points, a degree of similarity between the signal at a target point and a signal at the point included in the set in which the target point is included; and
an event determination step of determining, for each of the plurality of points, whether there is an event based on the degree of similarity between the signal at a target point and a signal at an adjacent point that is adjacent to the target point.

### (Supplementary Note 9)

The signal processing method according to supplementary note 8, wherein in the set generation step, for each of the plurality of points, an adjacent point that is adjacent to a target point is selected, and the selected adjacent point is included in the set in which the target point is included.

### (Supplementary Note 10)

The signal processing method according to supplementary note 9, wherein
the signal measurement apparatus is an apparatus configured to handle a signal measured at any gauge length as a signal at one point, and
in the set generation step, for each of the plurality of points, a point located within a range of a predetermined number times the gauge length from the target point is included in the set in which the target point is included.

### (Supplementary Note 11)

The signal processing method according to supplementary note 9, wherein in the set generation step, for each of the plurality of points, a point located within a range of a predetermined distance from the target point is included in the set in which the target point is included.

### (Supplementary Note 12)

The signal processing method according to supplementary note 8, wherein
in the degree of similarity calculation step,
signal processing is performed on the signal acquired by the signal acquisition step, and
a degree of similarity between the signals that have been subjected to the signal processing is calculated.

### (Supplementary Note 13)

A non-transitory computer readable medium storing a program for causing a computer to execute:
a signal acquisition procedure for acquiring signals measured by a signal measurement apparatus at a plurality of points located along an optical fiber; and
a determination procedure for determining whether there is an event based on a degree of similarity between the signals measured at adjacent points.

### (Supplementary Note 14)

The non-transitory computer readable medium according to supplementary note 13, wherein
the determination procedure comprises:
a set generation procedure for generating, for each of the plurality of points, a set including a point where a degree of similarity between a signal at this point and a signal at a target point is to be calculated;
a degree of similarity calculation procedure for calculating, for each of the plurality of points, a degree of similarity between the signal at a target point and a signal at the point included in the set in which the target point is included; and
an event determination procedure for determining, for each of the plurality of points, whether there is an event based on the degree of similarity between the signal at a target point and a signal at an adjacent point that is adjacent to the target point.

### (Supplementary Note 15)

The non-transitory computer readable medium according to supplementary note 14, wherein in the set generation procedure, for each of the plurality of points, an adjacent point that is adjacent to a target point is selected, and the selected adjacent point is included in the set in which the target point is included.

### (Supplementary Note 16)

The non-transitory computer readable medium according to supplementary note 15, wherein
the signal measurement apparatus is an apparatus configured to handle a signal measured at any gauge length as a signal at one point, and
in the set generation procedure, for each of the plurality of points, a point located within a range of a predetermined number times the gauge length from the target point is included in the set in which the target point is included.

### (Supplementary Note 17)

The non-transitory computer readable medium according to supplementary note 15, wherein in the set generation procedure, for each of the plurality of points, a point located within a range of a predetermined distance from the target point is included in the set in which the target point is included.

### (Supplementary Note 18)

The non-transitory computer readable medium according to supplementary note 16, wherein
in the degree of similarity calculation procedure,
signal processing is performed on the signal acquired by the signal acquisition procedure, and
a degree of similarity between the signals that have been subjected to the signal processing is calculated.

What is claimed is:

1. A signal processing apparatus comprising:
at least one memory configured to store instructions; and
at least one processor configured to execute the instructions to:
acquire signals measured by a signal measurement apparatus at a plurality of points located along an optical fiber; and
determine whether there is an event based on a degree of similarity between the signals measured at adjacent points.

2. The signal processing apparatus according to claim 1, wherein
the at least one processor is further configured to execute the instructions to:
generate, for each of the plurality of points, a set including a point where a degree of similarity between a signal at this point and a signal at a target point is to be calculated;
calculate, for each of the plurality of points, a degree of similarity between the signal at a target point and a signal at the point included in the set in which the target point is included; and
determine, for each of the plurality of points, whether there is an event based on the degree of similarity between the signal at a target point and a signal at an adjacent point that is adjacent to the target point.

3. The signal processing apparatus according to claim 2, wherein the at least one processor is further configured to execute the instructions to select, for each of the plurality of points, an adjacent point that is adjacent to a target point, and include the selected adjacent point in the set in which the target point is included.

4. The signal processing apparatus according to claim 3, wherein
the signal measurement apparatus is an apparatus configured to handle a signal measured at any gauge length as a signal at one point, and
the at least one processor is further configured to execute the instructions to include in the set in which the target point is included, for each of the plurality of points, a point located within a range of a predetermined number times the gauge length from the target point.

5. The signal processing apparatus according to claim 3, wherein the at least one processor is further configured to execute the instructions to include in the set in which the target point is included, for each of the plurality of points, a point located within a range of a predetermined distance from the target point.

6. The signal processing apparatus according to claim 2, wherein the at least one processor is further configured to execute the instructions to:
perform signal processing on the signal acquired by a signal acquisition unit; and
calculate a degree of similarity between the signals that have been subjected to the signal processing.

7. A signal processing method executed by a signal processing apparatus, the signal processing method comprising:
a signal acquisition step of acquiring signals measured by a signal measurement apparatus at a plurality of points located along an optical fiber; and
a determination step of determining whether there is an event based on a degree of similarity between the signals measured at adjacent points.

8. The signal processing method according to claim 7, wherein
the determination step comprises:
a set generation step of generating, for each of the plurality of points, a set including a point where a degree of similarity between a signal at this point and a signal at a target point is to be calculated;
a degree of similarity calculation step of calculating, for each of the plurality of points, a degree of similarity between the signal at a target point and a signal at the point included in the set in which the target point is included; and
an event determination step of determining, for each of the plurality of points, whether there is an event based on the degree of similarity between the signal at a target point and a signal at an adjacent point that is adjacent to the target point.

9. The signal processing method according to claim 8, wherein in the set generation step, for each of the plurality of points, an adjacent point that is adjacent to a target point is selected, and the selected adjacent point is included in the set in which the target point is included.

10. The signal processing method according to claim 9, wherein
the signal measurement apparatus is an apparatus configured to handle a signal measured at any gauge length as a signal at one point, and
in the set generation step, for each of the plurality of points, a point located within a range of a predetermined number times the gauge length from the target point is included in the set in which the target point is included.

11. The signal processing method according to claim 9, wherein in the set generation step, for each of the plurality of points, a point located within a range of a predetermined distance from the target point is included in the set in which the target point is included.

12. The signal processing method according to claim 8, wherein
in the degree of similarity calculation step,
signal processing is performed on the signal acquired by the signal acquisition step, and
a degree of similarity between the signals that have been subjected to the signal processing is calculated.

13. A non-transitory computer readable medium storing a program for causing a computer to execute:
a signal acquisition procedure for acquiring signals measured by a signal measurement apparatus at a plurality of points located along an optical fiber; and
a determination procedure for determining whether there is an event based on a degree of similarity between the signals measured at adjacent points.

14. The non-transitory computer readable medium according to claim 13, wherein
the determination procedure comprises:
a set generation procedure for generating, for each of the plurality of points, a set including a point where a degree of similarity between a signal at this point and a signal at a target point is to be calculated;
a degree of similarity calculation procedure for calculating, for each of the plurality of points, a degree of similarity between the signal at a target point and a signal at the point included in the set in which the target point is included; and
an event determination procedure for determining, for each of the plurality of points, whether there is an event based on the degree of similarity between the signal at a target point and a signal at an adjacent point that is adjacent to the target point.

15. The non-transitory computer readable medium according to claim 14, wherein in the set generation procedure, for each of the plurality of points, an adjacent point that is adjacent to a target point is selected, and the selected adjacent point is included in the set in which the target point is included.

16. The non-transitory computer readable medium according to claim 15, wherein
the signal measurement apparatus is an apparatus configured to handle a signal measured at any gauge length as a signal at one point, and
in the set generation procedure, for each of the plurality of points, a point located within a range of a predetermined number times the gauge length from the target point is included in the set in which the target point is included.

17. The non-transitory computer readable medium according to claim 15, wherein in the set generation procedure, for each of the plurality of points, a point located within a range of a predetermined distance from the target point is included in the set in which the target point is included.

18. The non-transitory computer readable medium according to claim 16, wherein
in the degree of similarity calculation procedure,
signal processing is performed on the signal acquired by the signal acquisition procedure, and
a degree of similarity between the signals that have been subjected to the signal processing is calculated.
